(19) United States
(12) Patent Application Publication
(10) Pub. No.: US 2002/0165766 A1
(43) Pub. Date: Nov. 7, 2002

(54) System and method for informing end user of electronic coupons

(75) Inventors: Ariel Schwartz, Tel-Aviv (IL); Ori Hartstein, Herzlia (IL); Gadi Friedman, Tel-Aviv (IL)

Correspondence Address: SHAHAN ISLAM, ESQ., Rosenman & Colin LLP, 575 Madison Avenue, New York, NY, 10022-2585, US

(73) Assignee: ENCLIP Inc.,, Ramat Hasharon (IL)

(21) Appl. No.: 09/731,058

(22) Filed: Dec. 6, 2000

(51) Int. Cl. G06F 17/60

(52) U.S. Cl. 705/14; 705/26

(57) ABSTRACT

A method and system for notifying and providing end-users with electronic promotional offer in relation to product/services in a displayed commercial network site. The system and method are implemented by computer program which monitors data of products and services in commercial network site and detect data, matching promotional offers which are stored at the user end or at any remote server. The relevant offers are reported to the end-user.

### BACKGROUND OF THE INVENTION

The invention relates to a method of accessing promotional material over a network, particularly relating to informing user of electronic coupon over the Internet.

For purposes of this disclosure, by the term “network” is meant at least two computers connected through a physical communication line, which can be hardwired, or virtual, such as satellite or other wireless communications. A computer can mean a personal computer, server or other similar-type device capable of receiving, transmitting, and/or manipulating data for such purposes as, but not limited to, display on a display unit connected thereto.

The usage of electronic coupons is known over the Internet network by both manufacturers and retailers of goods and services. Such sites provide a wealth of information about a specific manufacturer of retailer, and also provides an alternative way of distributing incentive and advertising information to consumers who have access to a computer network.

Although a consumer may locate any manufacturer's offers or retailer's product “specials” by exploring each of the manufacturer's and retailer's computer Web sites, most consumers will not have ready access to all of these sites and will not normally be motivated to search for special product deals or other promotions in this manner. One possible solution is to provide a central cooperative network site having a database of retailer specials and manufacturer offers (see U.S. Pat. No. 6,076,069). According to this solution the end users are required to reach and connect the central cooperative site before any commercial activity in order to be informed or advised of available promotional offers such as e-coupons.

It is thus the prime object of the invention to avoid the limitations of the prior art and to provide a system and method, of informing end users of promotional information such as e-coupons relating products or services 1o available in any given web-site.

### SUMMARY OF THE INVENTION

A method of notifying and providing and-users with electronic promotional offer in relation to products/services in a displayed commercial network site (“current site”), said method comprising the steps of: storing promotional offer relating said products/services(“offer data”); monitoring and detecting data of products/services in commercial network site (“product data”); detecting and Identifying correlation between product data and offer data of the end-user (“offer match”); and notifying end-user of offer match;

### BRIEF DESCRIPTION OF THE DRAWINGS

These and further features and advantages of the invention will become more clearly understood in the light of the ensuing description of a preferred embodiment thereof, given by way of example only, with reference to the accompanying drawings, wherein

FIG. 1 is a general diagrammatic representation of the environment in which the present invention is practiced;

FIG. 2 is a flow chart illustrating the process of promoting coupon in a network according to the present invention;

FIG. 3 is a flow-chart of illustrating the method of identifying products in commercial web-sites to end user according to the present invention;

### DETAILED DESCRIPTION OF THE PREFERRED EMBODIMENTS

The embodiments of the invention described herein are implemented as logical operations in a computing network system. The logical operations of the present invention are presented (1) as a sequence of computer implemented steps running on the computing network system and (2) as interconnected machine modules within the computing network system. The implementation is a matter of choice dependent on the performance requirements of the computing devises and network systems implementing the invention. Accordingly, the logical operations making up the embodiments of the invention described herein are referred to variously as operations, steps, or modules.

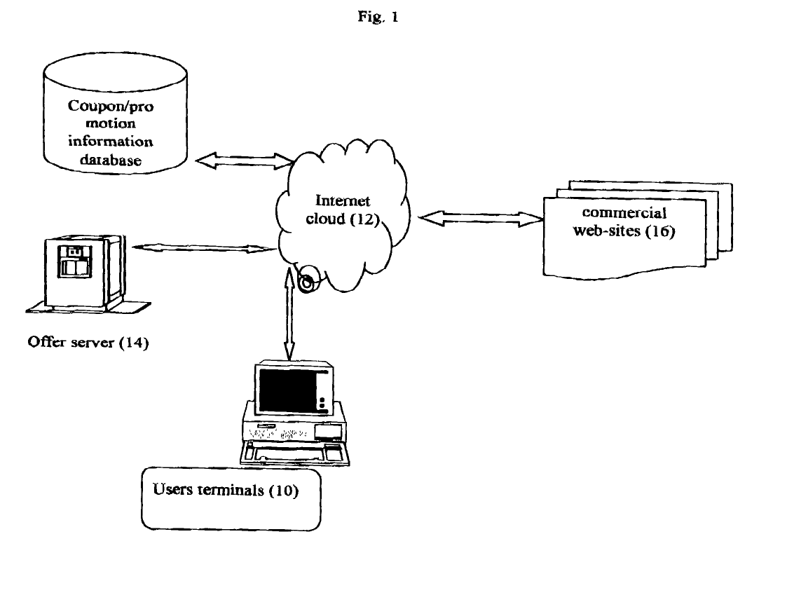

FIG. 1 illustrates the operating environment in which the present invention is used, As seen in FIG, 1, the user terminals 10 are connected to Internet cloud 12 The offer server 14 supervises promotional information such as e-coupon of products and services available in commercial web sites 16. Each user terminal 10 is equipped with advisor application enabling the users to identify products or service, which relate to promotional offers when surfing through the commercial web sites 16.

The operation of detecting and identifying the product and services can be processed by a designated application on the user end or alternatively by the offer server 14.

The promotional offers data of the users relating products and services of commercial web sites can be stored at the end or alternatively at the offer server 14.

The offers according to the present invention comprise two main elements of data information: The first element contains promotional information data such as the issuer identification, description, discount value, creation date, expiration date, related images, list of product/services to which the offer applies, usage restrictions etc. The second element contains data for identifying network locations of commercial web sites and web pages in which the offer can be used. All offer data can be changed dynamically by the end-user or the by the offer server.

For example, consider a promotional offer of 10% discount on a Harry Potter book at Amazon. com. The second element may contain identifying data such as the URL of the Amazon.com store (www.amazon.com), the URL of the promoted book itself (www.amazon.com/product id=444), a regular expression (Harry Potter*Amazon) that identify the content of a page in which the promoted product is presented and so on.

A promotional offer may be applicable in more than one network location (such as a manufacturer coupon).

The promotional offer can represent any digital data, such as an e-coupon, electronic cards (e.g. loyalty card, frequent shopper card), lottery ticket, sweepstake ticket, digital money and so on.

As mentioned above the offer data can be stored at the user end, hence the offer server 14 is not essential for implementing the present invention as described further bellow.

According to the first embodiment of the present invention the end-user is provided with an advisor application which has means to store promotional offers, for later use. The advisor application may store any kind of offer, for example, offer that is received via e-mail, collected (clipped) offers which appear as banners in a web site or as text in web a site or advertised in newspaper and so on.

Alternatively, the end-user may store the offer on a remote offer server 14 in a personal account.

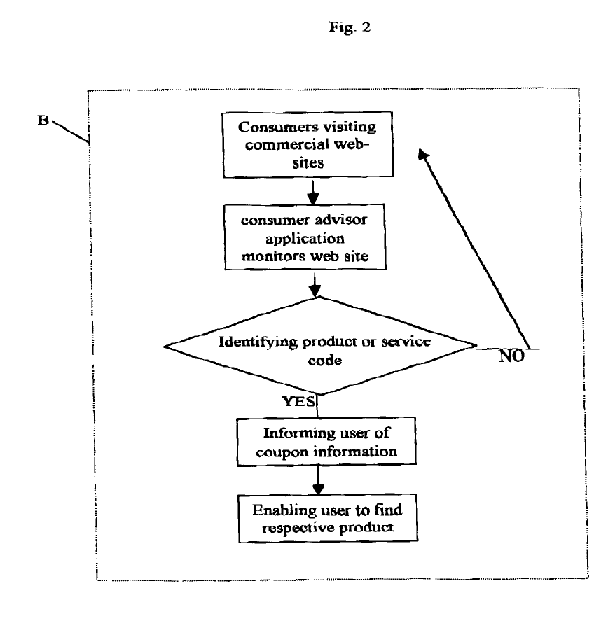

FIG. 2 describes the process of informing and indicating user while surfing in commercial web-site of available products or services provided in the said site in relation to promotional offers of the user.

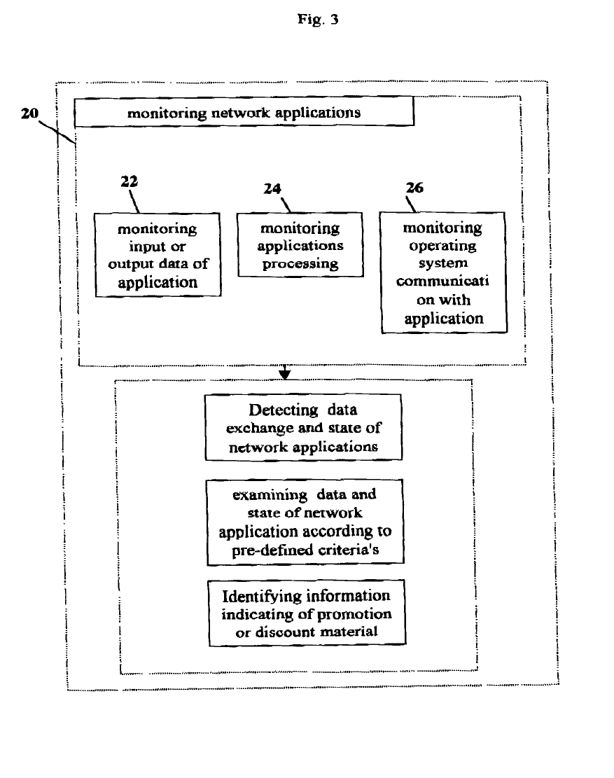

The advisor application monitors the user interaction with network, the monitoring operation can be achieved in different ways, as can be seen in FIG. 3.

According to option 22 the monitoring is done by tapping the “input” and “output” channels such as communication line, infra-red radio wave etc. of each network application, hence all data exchange of the user with network can be examined. The second option 24 enables direct connection of the advisor application to network applications code via exposed API such as COM interface in Windows. Such direct connection can be achieved also by changing the network application code, either before or at runtime. The third option enables indirect connection to network applications via operating system or any other program, which cooperates, with network applications.

The advisor application monitors any new data coming from the network in relation to the network application state and detects products/services identifying data(such as catalog number, name, network location etc. —hereinafter “product data”), of commercial web-sites which correlates with the promotional offers data of the user. For example, suppose that the user has an offer from Amazon that was described before. The advisor application monitors the current URL location of the user, comparing the current URLs (product data) to the promotional offers data of the user. In case of correlation between the product data-current URL and offer date (which contains network locations(URL) relating the offer) the user is informed and advised of the respective offer. Using the URL location parameter is just one possible example for detecting correlation between the product data and the offer data, optionally any object appearing in the relevant web page can serve for the same purpose.

According to a second embodiment of the present invention, the process of monitoring, detecting and informing/indicating the end-user of available products or services provided by a given commercial web site which have relation to promotional offers data of the use, is carried out by the offer server rather than by the advisor application (located at the user end).

One option of implementing the process of the second embodiment, is using cookies methodologies as follows: Upon entering a commercial web-site (“site server”), the end-user's browser is activated by the server site to open new invisible window at a new location address preferably at the offer server. This navigation command preformed preferably by java script contains a message sent by the site server, which identifies the referring site. Once the user is connected to the offer server, the identity of the end-user is detected by reading a cookie data, that was installed previously (by the offer server) when the end-user “clipped” an offer, or by asking the end-user to fill in an identity key. The offer server then compares the promotional offers data of the end-user to the product/service data, that was received from the referring page/site server. In case off correlation between the product data and the offer data, the end-user browser is activated to reveal the new opened window of the offer server and display the end user an appropriate message advising the user of available offers.

The advantage of the second embodiment as described above is by eliminating the need for a designated advisor application at the user end. Today, most internet and-users prefer to use services not requiring to download additional applications, hence such services have more commercial potential. On the other hand the above solution demands the commercial web-site to cooperate with the promotional offer service.

While the above description contains many specifities, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claimed is:

1. A method of notifying and providing end-users with electronic promotional offer in relation to products/services in a displayed commercial network site (“current site”), said method comprising the steps of:
A. Storing promotional offer relating said products/services(“offer data”);
B. Monitoring and detecting data of products/services in commercial network site (“product data”);
C. Detecting and Identifying correlation between product data and offer data of the end-user (“offer match”);
D. Notifying end-user of offer match;

2. The method of claim 1 wherein the offer data was recorded by the end-user or was received by the end-user in the past.

3. The method of claim 2 wherein the offer data is stored in the user terminal memory

4. The method of claim 2 wherein the promotional offer data is stored in a personal account located at a remote server.

5. The method of claim 1 wherein the promotional offer data can relate to more than one commercial network site.

6. The method of claim 1 wherein the offer data contains promotional information such as the issuer identification, description, discount value, creation date, expiration date, images, products/services to which the offer applies, usage restrictions etc.

7. The method of claim 1 wherein the offer data further contains identifying data of network locations of respective commercial web-sites (“identifying data”)

8. The method of claim 7 whereas the identifying data is in the form of URL code or regular expressions of text or cookies data, or binary data (such as gif image) or a combination of them.

9. The method of claim 7 wherein the identifying data is associated with a specific product/service or category of product/services (e.g. product catalog number);

10. The method of claim 7 further comprising the step of installing formatted data in the respective commercial web site, correlating with identifying data.

11. The method of claim 1 further comprising the step of dynamically updating the offer data;

12. The method of claim 1 whereas the promotional offer is an e-coupon, loyalty card, frequent shopper card, digital certificate e.g. lottery ticket, sweepstake ticket, movie ticket, digital money etc.;

13. The method of claim 1 wherein the detection and identification is done by a monitoring application on the end-user computer.

14. The method of claim 13 wherein the monitoring operation is being activated continuously, upon user request or upon any given schedule.

15. The method of claim 13 wherein the monitoring operation is implemented by taping input and/or output communication channels between end-user terminal and network;

16. The method of claim 13 wherein the monitoring operation is implemented by connecting to communication applications of the end-user terminal;

17. The method of claim 16 herein connection with the communication applications is achieved by changing said application program code;

18. The method of claim 16 wherein connection with the communication applications is done via the operating system or via other application which is connected to the communication applications;

19. The method of claim 16 wherein the communication application is a browser application;

20. The method of claim 13 whereas the monitoring application detects and identifies correlation between the end-users offer data and a product/service data according to predefined criteria's;

21. The method of claim 20 wherein the correlation is between the data offer and product data which appear at the currently displayed web page or any other web page associated with the current web-site;

22. The method of claim 1 whereas the detection and identification is initiated by the currently displayed site operated via a designated Server (“site server”);

23. The method of claim 22 further comprising the step of activating the end-user browsing application, by the site server, to perform any navigation command e.g. open a new window/frame/layer at new network location (“offer server”);

24. The method of claim 23 whereas the activating operation is processed using network software language e.g. Java script, VB script, Java applet etc

25. The method of claim 23 whereas the new window/frame/layer is invisible to the end-user (such as IFrame in Microsoft Internet Explorer).

26. The method of claim 23 whereas the navigation command holds a identifying parameter of the server site which initiated the navigation command.

27. The method of claim 23 whereas offer server identifies the end-user by reading a cookie data with the signature of the coupon server.

28. The method of claim 27 whereas the cookie was placed by the offer server at a previous occasion when the end-user received or stored a promotional offer data.

29. The method of claim 23 further comprising the step of demanding identifying key code from the user by offer server.

30. The method of claim 27 whereas identifying correlation between the end-user's offer data and the product data by the offer server according to pre-defined criteria's;

31. The method of claim 1 further comprising the step of enabling the end-user to redeem the promotional offers (“event”);

32. The method of claim 31 further comprising the step of determining whether to inform the user of the formatted data according to a set of rules:

33. The method of claim 1 further comprising the step of recording and logging the event and the user reaction;

34. The method of claim 1 further comprising the step of notifying the site server about offers data correlating the product data of the current site. The method of claim 31 further comprising the step of presenting the end-user with other promotional offers.

35. A system for notifying and providing end-users with electronic promotional offer in relation to products/services in a displayed commercial network site (“current site”), said system comprising:
A Storing means for recording promotional offer relating said products/services(“offer data”);
B. Monitoring means for detecting data of products/services in commercial network site (“product data”);
C. Comparing means for detecting correlation between product data and offer data of the and-user (“offer match”);
D. Notifying end-user of offer match;

36. The system of claim 35 wherein the offer data was recorded by the end-user or was received by the end-user in the past.

37. The system of claim 36 wherein the offer data is stored in the user terminal memory.

38. The system of claim 36 wherein the promotional offer data is stored in a personal account located at a remote server.

39. The system of claim 35 wherein the promotional offer data can relate to more than one commercial network site.

40. The system of claim 35 wherein the offer data contains promotional information such as the issuer identification, description, discount value, creation date, expiration date, images, products/services to which the offer applies, usage restrictions etc.

41. The system of claim 35 wherein the offer data further contains identifying data of network locations of respective commercial web-sites (“identifying data”)

42. The system of claim 41 whereas the identifying data is in the form of URL code or regular expressions of text or cookies data, or binary data (such as gif image) or a combination of them.

43. The system of claim 41 wherein the identifying data is associated with a specific product/service or category of product/services (e.g. product catalog number);

44. The system of claim 41 further comprising means for installing formatted data in the respective commercial web site, correlating with identifying data.

45. The system of claim 35 further comprising means for dynamically updating the offer date;

46. The system of claim 35 whereas the promotional offer is an e-coupon, loyalty card, frequent shopper card, digital certificate e.g. lottery ticket, sweepstake ticket, movie ticket, digital money etc.;

47. The system of claim 35 wherein the monitoring means and comparing means are located at the end-user terminal.

48. The system of claim 46 wherein the monitoring means are activated continuously, upon user request or upon any given schedule.

49. The system of claim 46 wherein the monitoring means is implemented by taping input and/or output communication channels between end-user terminal and network;

50. The system of claim 46 wherein the monitoring means are implemented by connecting to communication applications of the end-user terminal;

51. The system of claim 50 wherein connection with the communication applications is achieved by changing said application program code;

52. The system of claim 50 wherein connection with the communication applications is done via the operating system or via other application which is connected to the communication applications;

53. The system of claim 50 wherein the communication application is a browser application;

54. The system of claim 50 whereas the comparing means detect and identifies correlation between the end-user's offer data and a product/service data according to pre-defined criteria's;

55. The system of claim 54 wherein the correlation is between the data offer and product data which appear at the currently displayed web page or any other web page associated with the current web-site;

56. The system of claim 35 whereas the monitoring means are operated by the currently displayed site operated via a designated Server (“site servers”);

57. The system of claim 56 further comprising means for activating the end-user browsing application, by the site server, to perform any navigation command e.g. open a new window/frame/layer at new network location (“offer server”);

58. The system of claim 57 whereas the activating operation is processed using network software language e.g. Java script, VB script, Java applet etc.

59. The system of claim 57 whereas the new window/frame/layer is invisible to the end-user (such as IFrame in Microsoft Internet Explorer).

60. The system of claim 57 whereas the navigation command holds a identifying parameter of the server site which initiated the navigation command.

61. The system of claim 58 whereas offer comparing means are implemented by reading a cookie data by the offer server.

62. The system of claim 61 whereas the cookie data was placed by the offer server at a previous occasion when the end-user received or stored a promotional offer data.

63. The system of claim 57 further comprising means for receiving identifying key code from the user by offer server.

64. The system of claim 57 whereas identifying correlation between the end-user's offer data and the product data by the offer server according to pre-defined criteria's;
